(19) United States
(12) Patent Application Publication
(10) Pub. No.: US 2016/0203408 A1
(43) Pub. Date: Jul. 14, 2016

(54) SYSTEMS AND METHODS FOR A CLOUD-BASED ARTIFICIAL INTELLIGENCE ENGINE

(71) Applicant: KIMERA SYSTEMS, INC., Beaverton, OR (US)

(72) Inventor: Mounir Shita, Portland, OR (US)

(21) Appl. No.: 14/991,711

(22) Filed: Jan. 8, 2016

Related U.S. Application Data
(60) Provisional application No. 62/101,960, filed on Jan. 9, 2015.

(51) Int. Cl. G06N 7/00; H04L 29/08

(52) U.S. Cl. CPC G06N 7/005; H04L 67/10

(57) ABSTRACT

Systems and methods for a cloud-based artificial intelligence engine are provided. In one embodiment, a graph engine identifies an intention based on a loop around one or more subnets, a personal cloud generates an intelligence report based on the identified intention, and a user device performs actions based on the intelligence report and a confidence level of nodes within the loop above a threshold. In this way, a user device may perform actions informed by a global intelligence that understands contextual information while maintaining privacy control.

### CROSS REFERENCE TO RELATED APPLICATIONS

The present application claims priority to U.S. Provisional Patent Application No. 62/101,960, entitled “SYSTEMS AND METHODS FOR A CLOUD-BASED ARTIFICIAL INTELLIGENCE ENGINE,” filed on Jan. 9, 2015, the entire contents of which are hereby incorporated by reference for all purposes.

### BACKGROUND AND SUMMARY

Computerized personal assistants ostensibly programmed with artificial intelligence enable a user to use the features of a smart phone by voicing commands. However, such personal assistants rarely understand what is asked of them, let alone anticipate requests in real-time. In fact, much of the intelligent software may be considered sophisticated natural language processing systems connected to a search engine.

Meanwhile, computer users generated 2.8 zettabytes of digital information in 2012, and this amount is projected to increase annually at an exponential rate. Some of this data may be used to train artificial intelligence algorithms for computerized personal assistants. However, even with a gargantuan amount of personal data, such algorithms struggle with identifying and understanding contextual information.

Moreover, users are growing increasingly discontent with corporate and government surveillance of their personal data, and many users remain skeptical about the potential for technology to know everything about them. Users who create information using technology should be the rightful owners of their data. Thus, users need a way to assert ownership of their data and control how their data is used.

The inventors have recognized the above issues and have devised several approaches to resolve them. In particular, systems and methods for a cloud-based artificial intelligence engine are provided. In one embodiment, a personal cloud may graphically model hard and soft data received from a user device, where graphical models comprise a network of nodes and links. The personal cloud may calculate an effective probability for each node of the network. Abstracted versions of the graphical models, or subnets, may be sent to a graph engine that connects a plurality of subnets from a plurality of personal clouds to each other. In some examples, a user may control security settings and permissions on the personal cloud to determine what subnets are shared with the graph engine. The graph engine may identify intentions based on loops around one or more subnets. In this way, a user device may include an intelligent personal assistant that understands contextual information while maintaining privacy control.

In another embodiment, a system comprises: a first server providing a personal cloud; a second server providing a graph engine and configured to communicatively couple to the first server via a network to access the personal cloud; a user device configured to communicatively couple to the first server via the network to access the personal cloud, the user device including a plurality of sensors configured to generate data; wherein, upon receiving the data from the user device, the personal cloud is operable to generate a graphical model based on the data, wherein the graphical model comprises a subnet of nodes, each node comprising a private component and a public component, and wherein the graphical model includes a confidence level relating to a link between a first node and a second node of the subnet; wherein, upon receiving the public components of the subnet from the first server, the graph engine is operable to update a global graphical model stored within a data storage subsystem of the second server by connecting the public components of the subnet to public components of a second subnet received from a second personal cloud and included in the global graphical model; wherein, upon identifying a loop between the public components of the first and second subnets in the global graphical model, the graph engine is operable to transmit an indication of the loop to the first server; wherein, upon receiving the indication of the loop, the personal cloud is operable to transmit an intelligence report including at least one command generated based on the loop and the confidence level to the user device; and wherein, upon receiving the intelligence report from the first server, the user device is operable to perform the at least one command. In this way, spontaneously-generated data from a user device may be used to power a global intelligence system while protecting the privacy of a user, while the global intelligence system may in turn enable intelligent behavior of the user device.

### BRIEF DESCRIPTION OF THE DRAWINGS

FIG. 1 shows a computing environment according to an embodiment.

FIG. 2 shows a computing architecture according to an embodiment.

FIG. 3 shows an example graphical model of data on a personal cloud according to an embodiment.

FIG. 4 shows a high-level flow chart illustrating a method for a cloud operating system according to an embodiment.

FIG. 5 shows a high-level flow chart illustrating a method for authenticated access to a personal cloud according to an embodiment.

FIG. 6 shows a high-level flow chart illustrating a method for obtaining intelligence from a device according to an embodiment.

FIG. 7A shows an illustration of an example wherein a user arrives at a grocery according to an embodiment.

FIG. 7B shows a graphical representation of an example intent according to an embodiment.

### DETAILED DESCRIPTION

The present description relates to systems and methods for a cloud-based artificial intelligence. In particular, systems and methods are provided for processing system and user-generated data stored in a personal cloud.

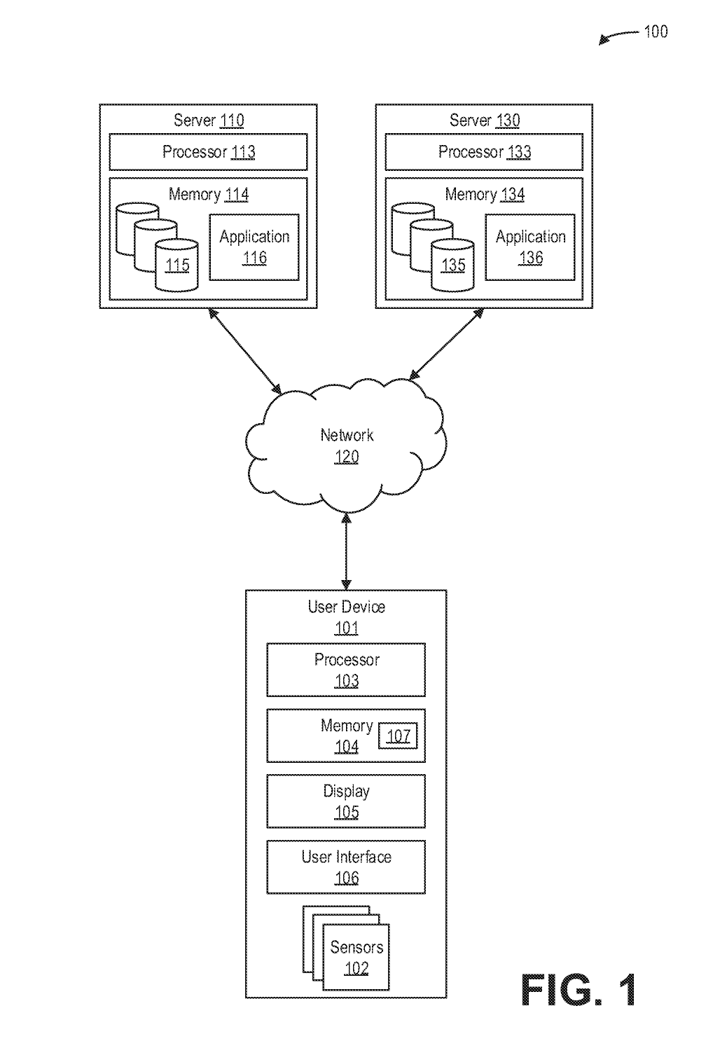

FIG. 1 shows an example computing environment 100 in accordance with the current disclosure. In particular, computing environment 100 shows how a user may connect one or more user devices 101 to a personal cloud remotely hosted on a server 110, and further how the personal cloud may connect to a graph engine remotely hosted on a server 130. A user device 101 may include a plurality of sensors 102 and/or applications stored in memory, and the user device may be configured to send data acquired via the plurality of sensors 102 and/or applications to the personal cloud via a network 120. The server 110 may process the data and dynamically generate knowledge of the user based on the processed data. The graph engine server 130 may process data received from the personal cloud server 110 to dynamically generate global intelligence.

A user device 101 may comprise any computing system. In different embodiments, the user device may take the form of a mainframe computer, server computer, desktop computer, laptop computer, tablet computer, home entertainment computer, network computing device, mobile computing device, mobile communication device, gaming device, etc.

User device 101 may include a processor 103, memory 104, and one or more sensors 102. User device may optionally include a display 105, a user interface 106, and/or other components not shown in FIG. 1. For example, user device 101 may include a communication subsystem (not shown) configured to send and/or receive data to a different computing device such as server 110 via a network 120.

The processor 103 may include one or more physical devices configured to execute one or more instructions. For example, the processor 103 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The processor 103 may include one or more processors that are configured to execute software instructions. Additionally or alternatively, the processor 103 may include one or more hardware or firmware logic machines configured to execute hardware or firmware instructions. The one or more processors may be single or multi-core, and the programs executed thereon may be configured for parallel or distributed processing. The processor 103 may optionally include individual components that are distributed throughout two or more devices, which may be remotely located and/or configured for coordinated processing. One or more aspects of the processor 103 may be virtualized and executed by remotely accessible networked computing devices configured in a cloud computing configuration.

Memory 104 may include one or more physical, non-transitory devices configured to hold data and/or instructions executable by the processor to implement the herein described methods and processes. When such methods and processes are implemented, the state of memory 104 may be transformed (for example, to hold different data).

Memory 104 may include removable media and/or built-in devices. Memory may include optical memory (for example, CD, DVD, HD-DVD, Blu-Ray Disc, etc.), and/or magnetic memory devices (for example, hard disk drive, floppy disk drive, tape drive, MRAM, etc.), and the like. Memory 104 may include devices with one or more of the following characteristics: volatile, nonvolatile, dynamic, static, read/write, read-only, random access, sequential access, location addressable, file addressable, and content addressable. In some embodiments, memory 104 and processor 103 may be integrated into one or more common devices, such as an application-specific integrated circuit or a system on a chip.

When included, the display 105 may be used to present a visual representation of data held by memory 104. As the herein described methods and processes change the data held by the memory 104, and thus transform the state of the memory 104, the state of the display 105 may likewise be transformed to visually represent changes in the underlying data. The display 105 may include one or more display devices utilizing virtually any type of technology. Such display devices may be combined with the processor and/or the memory in a shared enclosure, or such display devices may be peripheral display devices.

User device 101 may include a communication subsystem configured to communicatively couple user device 101 with one or more other computing devices, such as server 110. Communication subsystem may include wired and/or wireless communication devices compatible with one or more different communication protocols. As non-limiting examples, communication subsystem may be configured for communication via a wireless telephone network, a wireless local area network, a wired local area network, a wireless wide area network, a wired wide area network, etc. In some embodiments, the communication subsystem may allow the user device to send and/or receive messages to and/or from other devices such as server 110 via a network 120 such as the public Internet.

User device 101 may include one or more sensors 102 that generate data, referred to herein as hard data. Sensors 102 may include, for example, motion sensors (for example, accelerometers, gravity sensors, gyroscopes, rotational vector sensors, etc.), environmental sensors (for example, barometers, photometers, thermometers, humidity sensors, etc.), position sensors (for example, orientation sensors, magnetometers, GPS sensors, etc.), cameras, health monitors, and the like. User device 101 may be configured to send hard data to server 110 via network 120. In some examples, user device 101 may continuously send hard data to server 110. In other examples, user device 101 may send hard data to server 110 in regular time intervals. In yet other examples, user device 101 may send hard data to server 110 in response to a request for the hard data from server 110.

Furthermore, the one or more sensors 102 may record data regarding location data, incoming and outgoing phone calls, volume levels, Bluetooth status and transmissions, WiFi status and transmissions, incoming and outgoing messages, headphone status (e.g., headphones plugged into or removed from the user device 101), screen brightness, address book, and so on. In some examples, to preserve battery life of the user device 101, non-critical sensor changes may be temporarily stored on the user device 101 for up to several hours, for example, before a batch of the data is transmitted to the personal cloud server 110.

User device 101 may further include one or more applications 107 stored in memory 104. As described further herein, such applications may enable a user of user device 101 to input information, hereinafter referred to as soft data, to user device 101. Soft data may be sent to server 110 in a manner similar to hard data. For example, user device 101 may transmit soft data to server 110 continuously, in regular or irregular intervals, and/or in response to requests from server 110. Further, the user device 101 may receive intelligence reports from the personal cloud server 110 and/or the graph engine server 130, and the application 107 may be operable to perform actions responsive to the received intelligence reports as described further herein.

Server 110 may include a processor 113 and a memory 114, where the memory 114 may include data and/or instructions accessible and/or executable by processor 113. For example, memory 114 may include one or more databases 115 and one or more applications 116. In some examples, one or more databases 115 may comprise a personal cloud that includes data from user device 101 as well as processed data. In some examples, such data and processed data may be represented as graphical models comprising representations of a collection of objects, or nodes, where pairs of nodes may be connected by links. Application 116 may comprise a personal cloud operating system (OS) that manages the personal cloud 115 and provides services to server 110 and user device 101.

The server 110, also referred to herein as a personal cloud server 110, provides devices such as user device 101 with intelligence briefings comprising, for example, XML documents including one or more recommendations for device behavior, including but not limited to: opening web applications, changing volume, changing screen brightness, sending a message, initiating a phone call, rejecting a phone call, and so on.

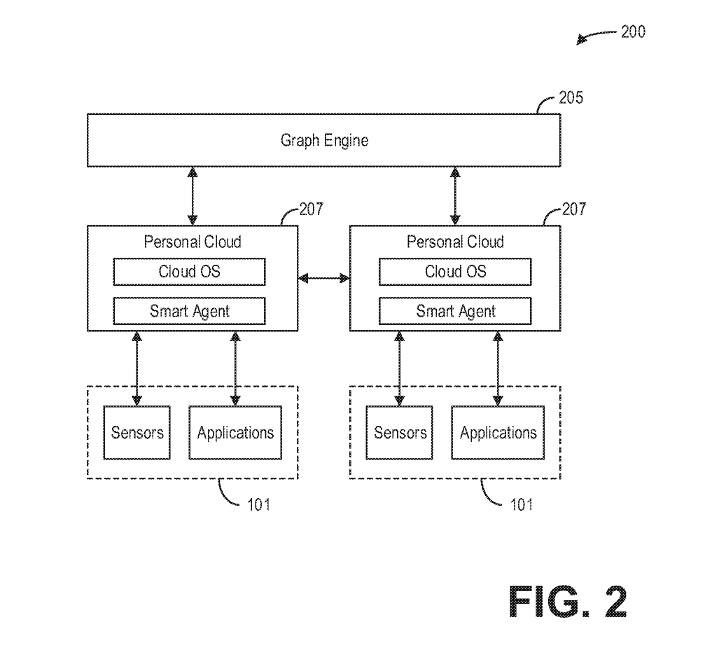

Similarly, server 130 may include a processor 133 and a memory 134, where the memory 134 may include data and/or instructions accessible and/or executable by processor 133. For example, memory 134 may include one or more databases 135 and one or more applications 136. As described further herein with regard to FIG. 2, application 136 may comprise a graph engine. The graph engine 136 may connect graphical models received by server 130 from a plurality of personal clouds (e.g., from server 110) to generate a global intelligence model.

Although the computing environment 100 depicted in FIG. 1 shows a single user device 101, a single personal cloud server 110, and a single graph engine server 130, it should be appreciated that a plurality of such devices may be included in computing environment 100. Specifically, a plurality of user devices such as user device 101 may connect, via a network 120, to a plurality of personal cloud servers 110. In some examples, a first plurality of user devices may be communicatively coupled via a network to a first personal cloud server, while a second plurality of user devices may be communicatively coupled to a second personal cloud server. In some examples, the first and second personal cloud servers may be communicatively coupled via the network to a single graph engine server. However, in other examples the computing environment may include a plurality of graph engine servers, such that a first plurality of personal cloud servers may be communicatively coupled to a first graph engine server while a second plurality of personal cloud servers may be communicatively coupled to a second graph engine server, and so on.

FIG. 2 shows an example computing architecture 200 in accordance with the current disclosure. In particular, computing architecture 200 includes a graph engine 205, one or more personal clouds 207, and one or more user devices 101. Graph engine 205 may be located on one or more remote computing devices, such as server 130, while the personal clouds 207 may similarly be located on one or more remote computing devices, such as server 110. Hard data generated by sensors in user device 101 and soft data generated by applications in user device 101 may be transmitted to the personal cloud 207. Computing architecture 200 may be implemented in computing environment 100 as described herein, however different components and/or arrangements of components may be used without departing from the scope of the invention.

Personal cloud 207 may include a personal cloud operating system (OS) and one or more smart agents. Personal cloud 207 may further include a graphical representation of data collected from sensors/input. Data may be classified as hard or soft data. Hard data comprises data from physical sensors and automatically-generated information, while soft data is input by a user, for example via a mobile application.

In some examples, a personal cloud 207 is a graphical representation of information regarding a person, place, concept, thing, etc. For example, each person, store, vehicle, and any other connected device may have a personal cloud. A personal cloud may be hosted on any server of choice on a global network. Furthermore, in some examples a personal cloud may be spontaneously generated from hard and/or soft data generated about other objects. Such spontaneously generated clouds may include a fixed duration of life.

Data collected by a personal cloud is stored in the form of graphs with linked nodes. As shown in FIG. 2, personal clouds can interact directly with other personal clouds. A user can set detailed security settings for sharing information. The node of each graph in a personal cloud is assigned a public, abstracted address and a private, intelligible address, wherein the private address may only be accessed within the personal cloud by the owner of the personal cloud, and wherein the public address may be transmitted to the graph engine and/or a separate personal cloud for processing. A graph of related information is a subnet. For example, a subnet may comprise a graph representing a particular recipe, a graph representing health conditions of the user, and so on. Some subnets may contain sensitive information and therefore may be undesirable for sharing with the personal clouds of other users. Users can assign detailed security settings to each subnet in order to control what is sharable and what is truly private.

The graphs from a personal cloud are sent to the graph engine 205 with only the abstracted address information. The graph engine 205 stitches all abstracted graphs together and processes all nodes and links to develop a global intelligence model. By utilizing the public, abstracted addresses, the graph engine may develop a global intelligence model without explicit knowledge of what the intelligence may represent.

An intent comprises a circular link between nodes from different subnets. For three subnets, for example, an intent may comprise a first node in a first subnet linked to a second node in a second subnet, where the second node is linked to a third node in a third subnet and the third node is linked to the first node.

Smart agents within each personal cloud process requests. Smart agents comprise applications stored within a personal cloud that, continuously or responsive to requests and/or events, process information in the personal cloud and/or beyond the personal cloud, for example in other personal clouds.

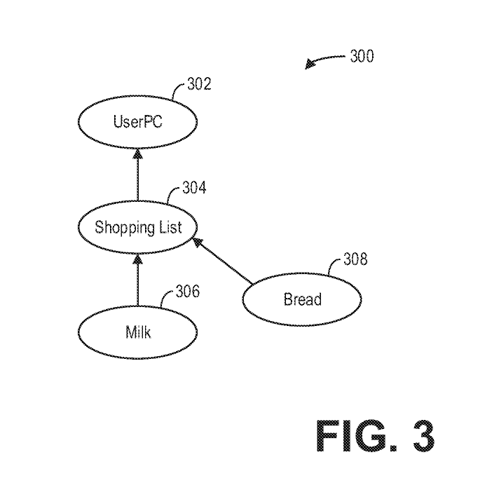

A personal cloud stores data from sensors and applications in a graph-based representation. Connections between vertices are controlled by the graph engine. For example, a user may add milk to a shopping list via a shopping list application. As shown in FIG. 3, the user's personal cloud generates a graph 300 that connects a milk vertex 306 to a shopping list vertex 304. The shopping list vertex 304 may be linked to a specific user personal cloud, such as UserPC vertex 302. The shopping list vertex 304 may be connected to additional vertices, such as the bread vertex 308, indicating that bread has also been added to the shopping list. The connections, or synapses, also include temporal information, for example a timestamp indicating when milk is added to the shopping list. The graph 300 is then sent to the graph engine 205. Each graph engine serves many personal clouds. The graph engine connects graphs from each personal cloud into one universal graph which represents the world. In some examples, one or more independent graph engines may process graphs independent of each other. In such examples, independent graph engines may synchronize all or some of their graphs so that each graph engine operates on the same global intelligence.

The personal cloud and/or the graph engine may compute effective probabilities for each node. For example, the graph engine may generate XML for the graphical model, an effective probability function may be parsed through each subnet node. At each node, the graph engine may extract each device behavior and calculate an effective probability of the node. In some examples, a user may establish personal super rules that take precedence over any automatically calculated effective probability. The graph engine may then add the device behavior with effective probability directly into the XML.

As users interact with applications and sensors in a user device, graphs are dynamically created to represent what the user is doing. For example, a user may indicate via an app that he or she does not like house salad. The personal cloud may then create a negative graph for house salad. The graph engine will create a new, or process existing, graph to reflect negative feedback.

Synapse confidence may be indicated on a confidence scale from 0 to 100, where 0 is the most negative and 100 is the most positive. For example, from 0-10 (90-100), the graph engine may be super confident that a preference within this range is a negative (positive) preference. From 10-30 (70-90), the graph engine is fairly confident about this negative (positive) relationship. From 30-45 (55-70), the graph engine may be neutral about preferences within this range. Such neutral synapses have no impact on confidence calculations. From 45-55, the graph engine may “forget” a preference within this range. For example, synapses that stay too long in this range are “forgotten” and eventually archived or deleted. All new synapses begin with a confidence rating of 50. For a synapse to survive, the synapse needs regular positive or negative stimulus.

The personal cloud may be hosted on any server of choice anywhere on the global network. Distributing personal clouds across the network creates many small and unattractive targets for hackers (for example, illegal hackers in addition to “legal” government hacking such as National Security Agency). Instead of a user device sending data to a corporation associated with the user device, such as Google Inc. or Apple Inc., or a mobile application such as Facebook, Inc. sending data to a Facebook server farm, according to the present invention, all data from a user device may be sent to personal cloud that is owned and controlled by the user of the user device.

The personal cloud server runs the personal cloud OS. Smart agents run on top of the personal cloud OS. The purpose of a personal cloud is to act as a digital representation of someone or something. For example, personal clouds may be for humans, a device, an intersection, a word, a painting, an organization, an idea, etc. By connecting hard and soft sensors to the personal clouds, the global model is continuously updated just by people living their life.

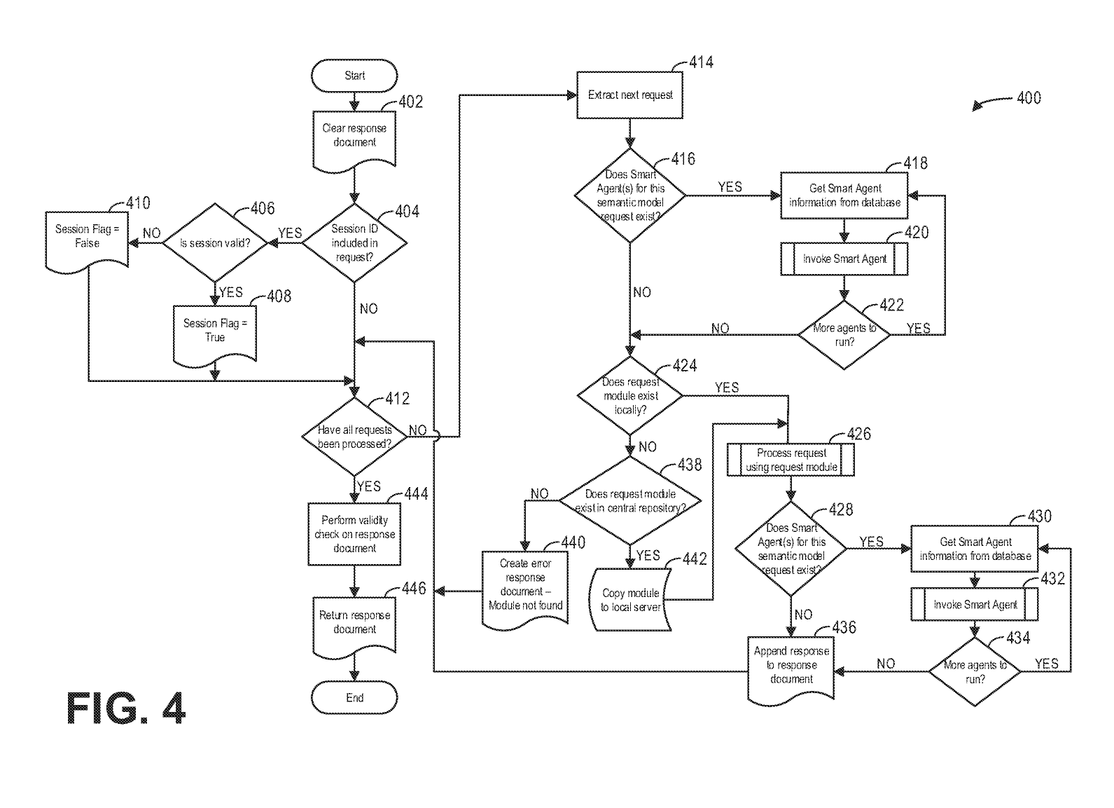

FIG. 4 shows a high-level flow chart illustrating a method 400 for the personal cloud operating system. In particular, method 400 relates to servicing requests on a personal cloud. Method 400 may be stored as instructions in non-transitory memory in a personal cloud.

Method 400 initializes upon receiving one or more requests from a user device, and begins at 402 by clearing a response document. If a session ID is included in the request, method 400 may include steps 406 for determining if the session is valid and setting a session flag to true at 408 or false at 410.

Method 400 may then continue to 412 to determine if all requests are processed. If not, method 400 extracts the request at 414 and continues to 416 to determine if one or more smart agents for the semantic model of the request exists. If a smart agent for the semantic model of the request exists, method 400 may include getting the smart agent information from a database at 418 and invoking the smart agent at 420. At 422, method 400 may repeatedly get smart agent information from the database and invoking the smart agent until all smart agents necessary to process the request are invoked. After each relevant smart agent is invoked, or if there are no smart agents for the semantic model of the request at 422, method 400 proceeds to 424 to determine if the request module locally exists. If the request module exists locally, the request is processed at 426 using the request module. If the request module does not exist locally, method 400 determines if the request module exists in a central repository at 438. If the request module exists in the central repository, the request module is copied to the local server, or personal cloud, at 442 and the request is processed using the request module at 426. If the request module does not exist in the central repository, method 400 may include creating an error response document at 440 indicating that a module for the request was not found, and the request is not processed any further.

After processing the request using the request module at 426, method 400 may include determining if a smart agent for the semantic model response exists at 428. If so, method 400 may include getting smart agent information from a database at 430 and invoking the smart agent at 432 until all smart agents for the semantic model response are invoked. After invoking the smart agent, or if no smart agents exist for the semantic model response at 434, method 400 may include appending a response to the response document at 436. Method 400 may then return to determining if all requests have been processed at 412.

After all requests are processed, method 400 may include performing a validity check on the response document at 444. Performing a validity check on the response document may include ensuring that a valid response is generated for each request, wherein a valid response may comprise a properly formatted response, or a non-null response. Method 400 may then include returning the response document at 446 to the device that initially formed the request. Method 400 may then end.

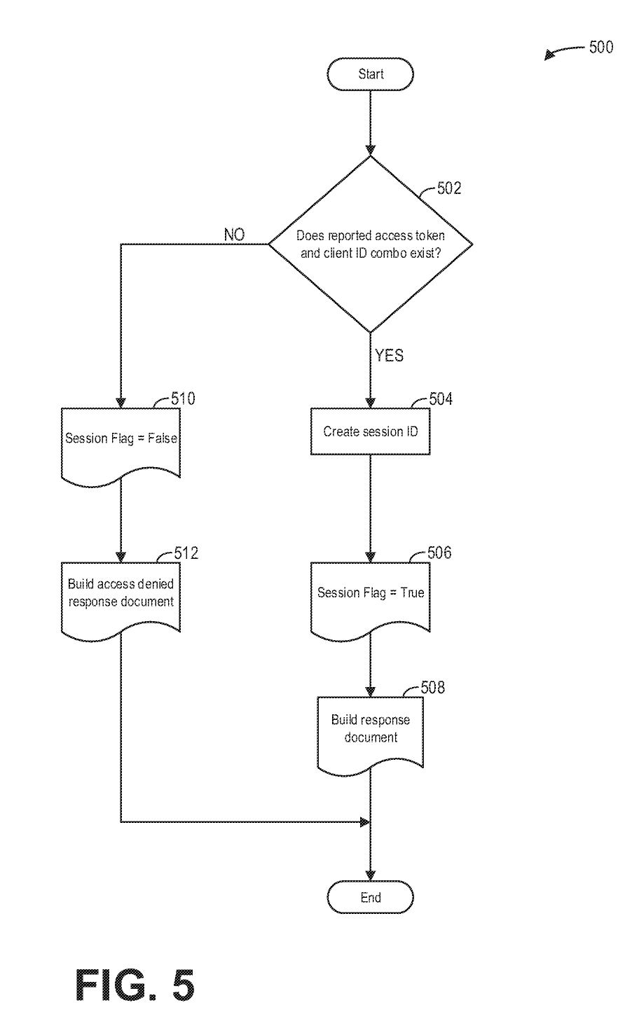

FIG. 5 shows a high-level flow chart illustrating an example method 500 for authentication via the personal cloud operating system.

Method 500 may begin at 502 by determining if a reported access token and client ID combination exist. If the combination exists, method 500 may include creating a session ID at 504 and setting a session flag to true at 506. Method 500 may then include building a response document at 508. If the combination does not exist, the session flag may be set to false at 510. Method 500 may then include building an access denied response document at 512. After building a response document, method 500 may then end.

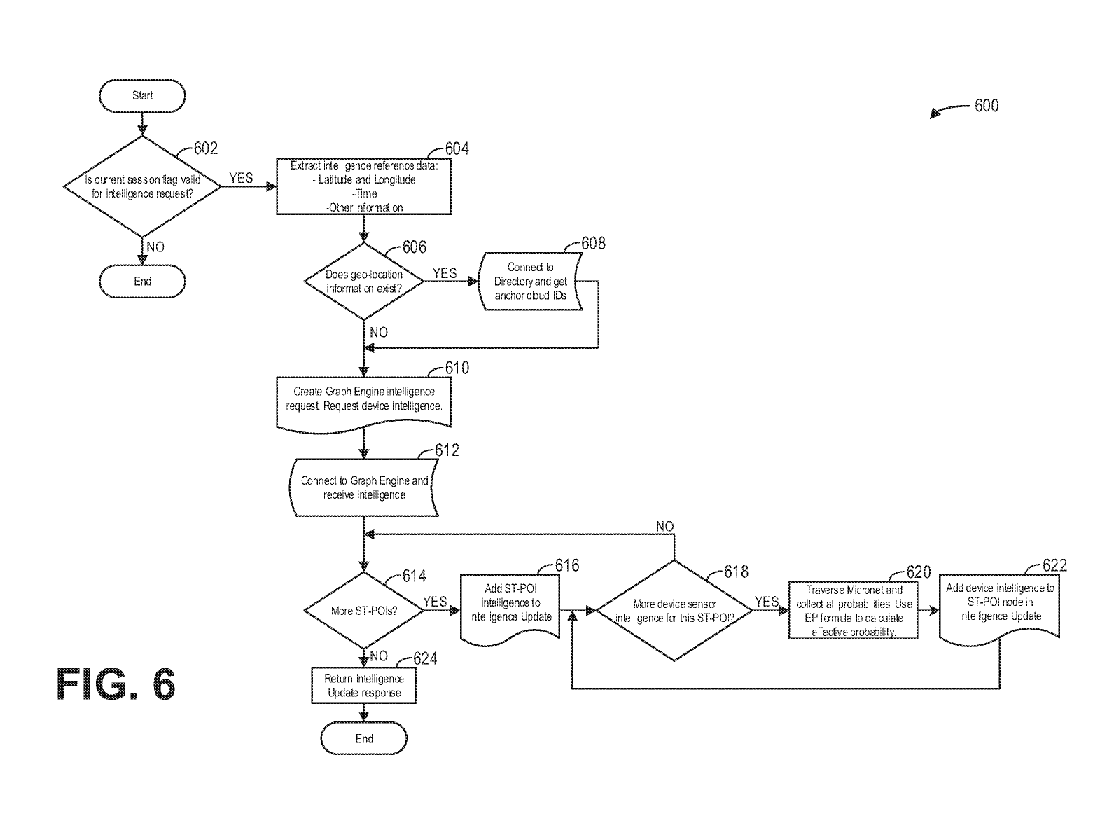

FIG. 6 shows a high-level flow chart illustrating an example method 600 for a device intelligence module. Method 600 may be stored as executable instructions in server 110.

Method 600 may begin at 602 by determining if the current session flag is valid for an intelligence request, for example as described hereinabove with regard to FIG. 5. If the session flag is set to false, method 600 may promptly end. If the session flag is set to true, method 600 may further include extracting intelligence reference data at 604. Intelligence reference data may include, but is not limited to, latitude and longitude of the device, time of the request, and other information.

Method 600 may then include determining if geolocation information exists at 606. If geolocation information exists, method 600 may include connecting to a directory and getting anchor cloud IDs at 608. The directory may comprise a look-up table stored in the graph engine or the personal cloud. Anchor cloud IDs may be associated, for example, with personal clouds connected to a permanent location. Method 600 may then proceed to creating a graph engine intelligence request and sending the device intelligence request to the graph engine at 610.

Method 600 may include connecting to the graph engine and receiving intelligence at 612. Method 600 may then include determining if more space-time points of interest (ST-POI) exist at 614. A space-time point-of-interest comprises an event associated with a location and/or a time. If so, method 600 may include adding the ST-POI intelligence to the intelligence update at 616. If more device sensor intelligence for the ST-POI exists 618, method 600 may further include traversing a micronet and collecting all probabilities at 620, in addition to calculating effective probabilities (EP) if probabilities are not pre-calculated. Method 600 may then include adding device intelligence to the ST-POI node in an intelligence update at 622. Method 600 may repeat this process until all device sensor intelligence for the ST-POI is included in the intelligence update. Method 600 may then include returning the intelligence update response at 624. Method 600 may then end.

The effective probabilities comprise the confidence levels described herein, and, as they are probabilities, preferably range from 0 to 100. As illustrative examples, formulas for effective probabilities may comprise weighted averages, unweighted averages, and so on of the temporal weighted directed or undirected graphs.

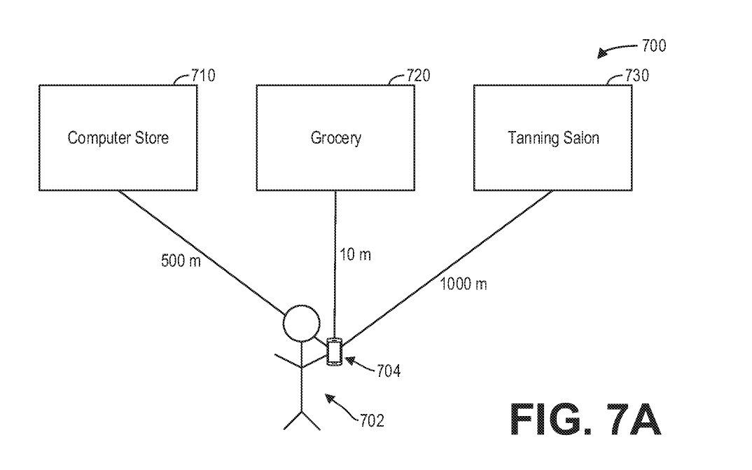

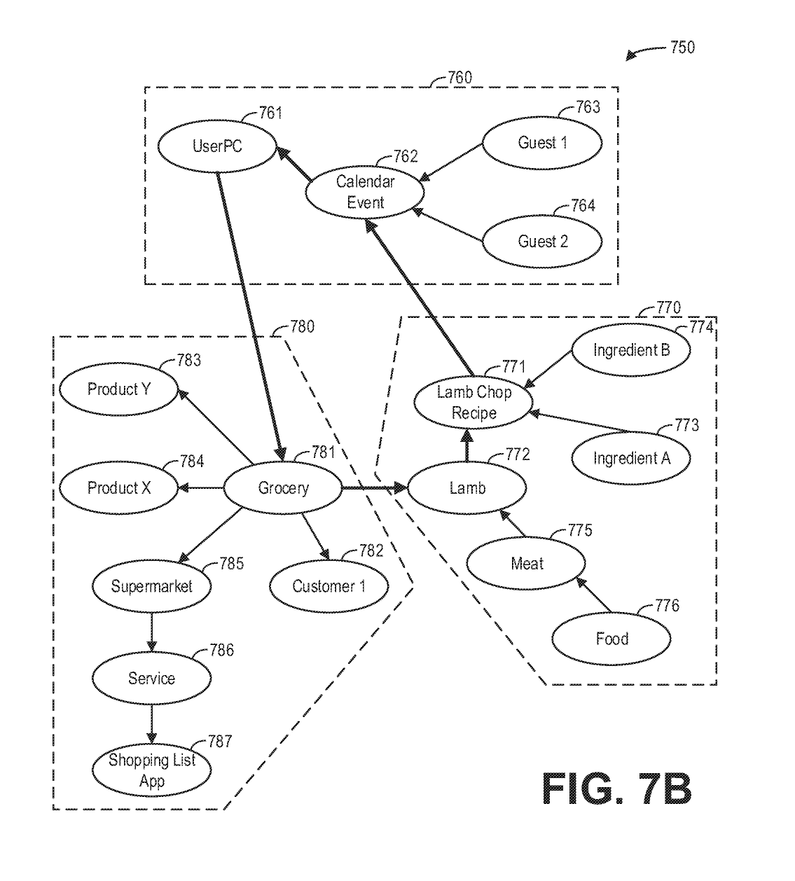

FIG. 7A shows an illustration of an example 700 wherein a user 702 arrives at a grocery 720 according to an embodiment. As the user approaches the grocery store 720, the user device 704 may transmit location data to the personal cloud to determine which business the user 702 is approaching. Furthermore, the graph engine may identify an intention for visiting the business based on a circular connection between subnets.

The user device sends the position (e.g., latitude/longitude) to the personal cloud. The personal cloud looks up what fixed-point personal clouds are located in close proximity using a directory service, where the directory service may be located in the graph engine or as a stand-alone database. In some examples, the fixed-point personal cloud IDs may be transmitted by the location using, for example, WiFi, Bluetooth, NFC, RFID, QR codes, and the like. The personal cloud may find, for example, three personal cloud IDs, each corresponding to the computer store 710, the grocery 720, and the tanning salon 730. The personal cloud generates three graphs, where each graph starting point is the user's personal cloud ID and the end point is the personal cloud ID for each business. The personal cloud may send the abstracted components of the graphs to the graph engine. The graph engine may then compute an effective probability, or weight, for each graph where the weight may be, for example, a function of distance and accuracy. In some examples, the weight may be adjusted according to a historical coefficient based on how often the user visits the particular business. The graph engine may traverse any subnets for which the weight is greater than a threshold. If a “service” node is found, corresponding application information may be sent to the personal cloud.

FIG. 7B shows a graphical diagram 750 of an example intent according to an embodiment. A personal cloud 760 associated with a user 702 includes a calendar event 762, which may comprise, for example, a dinner party. The personal cloud includes two nodes for a pair of guests 763 and 764, indicating that the user has invited two guests to the calendar event 762. The user 702 has further selected a lamb chop recipe 771 to use when preparing dinner for the dinner party, where lamb chop recipe subnet 770 includes all nodes associated with the lamb chop recipe 771, such as the ingredient lamb 772, ingredient A 773, and ingredient B 774. In some examples, a node may be further connected to nodes in order to provide context. For example, lamb 772 is connected to a meat node 775 which is connected to a food node 776 to indicate that lamb 772 refers to a food product and not the living animal.

As the user approaches the grocery 720 as shown in FIG. 7A and the graph engine determines that the user 702 is indeed approaching the grocery 720, an anchor cloud ID 781 associated with the grocery connects to the user personal cloud ID, or UserPC 761. The grocery subnet 780 may include information regarding the grocery store 720, such as the anchor ID 781, nodes 783 and 784 regarding various products for sale in the grocery, a node indicating a customer 782 in the store. In some examples, the grocery node 781 may be connected to a supermarket node 785 to indicate a category of the anchor ID, and furthermore if the category is associated with a service 786 such as a shopping list application 787, the grocery subnet 780 may include such nodes as well. The graph engine traverses the connected subnets (including, for example, the user subnet 760, the grocery subnet 780, and the lamb chop recipe subnet 770) and recognizes a loop between subnets: UserPC 761 is at the Grocery 781, the Grocery 781 sells Lamb 772, Lamb 772 is in the Lamb Chop Recipe 771, the Lamb Chop Recipe 771 is saved for the Calendar Event 762, and the Calendar Event 762 belongs to UserPC 761. The graph engine returns an intelligence update to the personal cloud, the intelligence update indicating an identified intent to purchase lamb 772 at the grocery 781. The intelligence update including the identified intent may be utilized by a smart agent or an application on the user device, for example, to indicate to the user 702 the intention to purchase lamb while at the grocery, alert the user to the location of lamb in the grocery, indicate a savings on lamb products, and/or any action based on the identified intention.

As another example, a Service node may reference an application that controls user device settings. When a user enters a movie theater, for example, the geolocation information may be transmitted to the personal cloud. The personal cloud obtains the movie theater anchor cloud ID from the directory and connects to the movie theater cloud. The graph engine traverses the abstracted subnets and determines that global behavior stored in the graph engine, based on the actions of other users connected to the movie theater anchor cloud ID, includes a dimming of a user device display and a muting of the user device volume. The graph engine may also encounter the Service node connected to the user device settings application. The graph engine may return this intelligence update to the personal cloud and/or the user device. The user device settings application may then reduce the brightness of the user device display and mute the user device volume. In this way, the graph engine may calculate effective probabilities for nodes in a subnet that only contains abstracted information in order to enable specific, functional results on a user device.

As another example, a user device sends a GPS location corresponding to a grocery store to its corresponding personal cloud. The personal cloud looks up a personal cloud ID for the grocery store and transmits a plurality of graphs to the graph engine, where each graph comprises two vertices linked (e.g., user PC ID and grocery PC ID). Each graph may include additional information, including but not limited to confidence level, valid time frame, and whether the graph is directed or undirected. Typically a personal cloud transmits dozens (or even hundreds) of such graphs at any time. Additional graphs describe the complete status of a device and other information captured by the personal cloud.

An example subnet generated by a user device belonging to a user who arrives at a grocery store and silences the user device (i.e., reduces volume level to zero), turns on WiFi and changes screen brightness to 75%, may include nodes for each action occurring at the grocery store which are connected to a node identifying the grocery store. New graphs are created for changes. For example, if the above user had silenced his phone prior to arriving at the grocery store, the volume graph would not be present in the example subnet.

One use for such subnets is for the concept learning stage. Another use is for simple learning. For example, if a majority of users silence their phones at movie theaters, eventually the confidence level (C) will be high enough for the graph engine to know that is normal to silence a user device when the user device is in a movie theater. The machine learning portion takes these graphs and adds it to its own global model. As more personal clouds deliver their graphs to the graph engine, the graph engine is able to develop a detailed model of the past, present and future of the world. Each of these graphs represents spatial information while the graph attributes include temporal information. Combined multiple graphs create a spatial and temporal view of the world that spans from the past to the future.

The machine learning portion also incorporates a pattern matching background process. The machine learning part is 100% independent of the concept learning and intelligence step. Once graphs are delivered to the machine learning, the graph engine delivers an acknowledgement response. Concept learning is key for human-like intelligence. It allows the graph engine to show evidence that it comprehends the world around it. The concept learning stage is connected to the machine learning input where it receives the same data input and has access to the same world models as the machine learning stage. However, concept learning operates independently in the background and provides no output response to the personal cloud.

As an illustrative example, if a user arrives at home and says “home” to user device, the personal cloud may generate a plurality of graphs linking the word “home” to each device state (e.g., location, time, user PC ID, and so on). As the user continues to say “home” to the user device each time the user arrives at home, all graphs except for the graphs linking the user PC ID and the location to “home” would have a reduced confidence level, because the user will likely arrive at home at different times and with different device states (e.g., volume level, brightness level, and so on). Over time the confidence level associated the user PC ID and the location to “home” would increase to a level where the personal cloud is confident that “home” refers to either the user and/or the particular location. When other users perform the same test, the graph engine eventually learns that “home” may mean locations for different users, and eventually the confidence level of the link between the user PC ID and “home” decreases.

Thus, systems, apparatuses, and methods are provided to enable an artificial intelligence. In one embodiment, a system comprises: a first server providing a personal cloud; a second server providing a graph engine and configured to communicatively couple to the first server via a network to access the personal cloud; a user device configured to communicatively couple to the first server via the network to access the personal cloud, the user device including a plurality of sensors configured to generate data; wherein, upon receiving the data from the user device, the personal cloud is operable to generate a graphical model based on the data, wherein the graphical model comprises a subnet of nodes, each node comprising a private component and a public component, and wherein the graphical model includes a confidence level relating to a link between a first node and a second node of the subnet; wherein, upon receiving the public components of the subnet from the first server, the graph engine is operable to update a global graphical model stored within a data storage subsystem of the second server by connecting the public components of the subnet to public components of a second subnet received from a second personal cloud and included in the global graphical model; wherein, upon identifying a loop between the public components of the first and second subnets in the global graphical model, the graph engine is operable to transmit an indication of the loop to the first server; wherein, upon receiving the indication of the loop, the personal cloud is operable to transmit an intelligence report including at least one command generated based on the loop and the confidence level to the user device; and wherein, upon receiving the intelligence report from the first server, the user device is operable to perform the at least one command.

In a first example of the system, upon generating the graphical model, the personal cloud is operable to update a personal cloud database stored in a data storage subsystem of the first server with the graphical model. In a second example of the system optionally including the first example, the data includes one or more of an indication of location, an indication of volume changes, an indication of screen brightness changes, an indication of headphone connection, an indication of a network service status, and an indication of communications performed by the user device. In a third example of the system optionally including one or more of the first and second examples, the graphical model includes temporal data relating to the data, and wherein the intelligence report is generated by the personal cloud based on the temporal data. In a fourth example of the system optionally including one or more of the first through third examples, the graphical model is formatted using extensible markup language (XML). In a fifth example of the system optionally including one or more of the first through fourth examples, the at least one command comprises one or more of adjusting volume of the user device, adjusting screen brightness of the user device, executing an application stored within the user device, and transmitting a message from the user device. In a sixth example of the system optionally including one or more of the first through fifth examples, the personal cloud is operable to update the confidence level of the link between the first node and the second node responsive to receiving additional data relating to the first node and the second node from the user device. In a seventh example of the system optionally including one or more of the first through sixth examples, the personal cloud is operable to update the confidence level of the link between the first node and the second node responsive to receiving additional data relating to the first node and the second node from the graph engine. In an eighth example of the system optionally including one or more of the first through seventh examples, the personal cloud is operable to generate the at least one command based on the confidence level when the confidence level is above a threshold.

In another embodiment, an apparatus comprises: a first server providing a personal cloud that is accessible to a user through a user device communicatively coupled to the first server via a network; and a data storage system storing a personal cloud database that is maintained by the first server, the personal cloud database comprising a plurality of graphical models generated by the personal cloud based on data received from the user device, the plurality of graphical models including at least one graphical model comprising a first node, a second node, and a confidence level indicating a connection between the first node and the second node; wherein the personal cloud is operable to transmit an abstracted form of the at least one graphical model to a second server providing a graph engine and communicatively coupled via the network to the first server; wherein, upon receiving an indication from the second server of a loop between the first node, the second node, and a third node of a graphical model maintained by the graph engine, the personal cloud is operable to generate an intelligence report including at least one command based on the indication of the loop and the confidence level; and wherein the personal cloud is further operable to transmit the intelligence report to the user device responsive to the confidence level above a threshold.

In a first example of the apparatus, the personal cloud is operable to update the confidence level responsive to receiving additional data relating to the first node and the second node from the user device. In a second example of the apparatus optionally including the first example, the data includes one or more of an indication of location, an indication of volume changes, an indication of screen brightness changes, an indication of headphone connection, an indication of a network service status, and an indication of communications performed by the user device. In a third example of the apparatus optionally including one or more of the first and second examples, the at least one command comprises one or more of adjusting volume of the user device, adjusting screen brightness of the user device, executing an application stored within the user device, and transmitting a message from the user device. In a fourth example of the apparatus optionally including one or more of the first through third examples, the personal cloud is operable to transmit the intelligence report to the user device responsive to a second confidence level above a threshold, the second confidence level indicating a connection between the first node and the third node.

In yet another embodiment, a method comprises: providing, at a first server, a personal cloud that is accessible to a user through a user device communicatively coupled to the first server via a network; maintaining, in a data storage system, a personal cloud database comprising a plurality of graphical models generated by the personal cloud based on data received from the user device, the plurality of graphical models including at least one graphical model comprising a first node, a second node, and a confidence level indicating a connection between the first node and the second node; transmitting an abstracted form of the at least one graphical model to a second server providing a graph engine and communicatively coupled via the network to the first server; receiving an indication from the second server of a loop between the first node, the second node, and a third node of a graphical model maintained by the graph engine; generating an intelligence report including at least one command based on the indication of the loop and the confidence level; and transmitting the intelligence report to the user device responsive to the confidence level above a threshold.

In a first example of the method, the method further comprises updating the confidence level stored in the personal cloud database responsive to receiving additional data relating to the first node and the second node from the user device. In a second example of the method optionally including the first example, the method further comprises updating the confidence level stored in the personal cloud database responsive to receiving additional data relating to the first node and the second node from the second server. In a third example of the method optionally including one or more of the first and second examples, the data received from the user device includes one or more of an indication of location, an indication of volume changes, an indication of screen brightness changes, an indication of headphone connection, an indication of a network service status, and an indication of communications performed by the user device. In a fourth example of the method optionally including one or more of the first through third examples, the at least one command comprises one or more of adjusting volume of the user device, adjusting screen brightness of the user device, executing an application stored within the user device, and transmitting a message from the user device. In a fifth example of the method optionally including one or more of the first through fourth examples, the at least one graphical model includes temporal data relating to the data, and wherein the intelligence report is generated based on the temporal data.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A system, comprising:
a first server providing a personal cloud;
a second server providing a graph engine and configured to communicatively couple to the first server via a network to access the personal cloud;
a user device configured to communicatively couple to the first server via the network to access the personal cloud, the user device including a plurality of sensors configured to generate data;
wherein, upon receiving the data from the user device, the personal cloud is operable to generate a graphical model based on the data, wherein the graphical model comprises a subnet of nodes, each node comprising a private component and a public component, and wherein the graphical model includes a confidence level relating to a link between a first node and a second node of the subnet;
wherein, upon receiving the public components of the subnet from the first server, the graph engine is operable to update a global graphical model stored within a data storage subsystem of the second server by connecting the public components of the subnet to public components of a second subnet received from a second personal cloud and included in the global graphical model;
wherein, upon identifying a loop between the public components of the first and second subnets in the global graphical model, the graph engine is operable to transmit an indication of the loop to the first server;
wherein, upon receiving the indication of the loop, the personal cloud is operable to transmit an intelligence report including at least one command generated based on the loop and the confidence level to the user device; and
wherein, upon receiving the intelligence report from the first server, the user device is operable to perform the at least one command.

2. The system of claim 1, wherein, upon generating the graphical model, the personal cloud is operable to update a personal cloud database stored in a data storage subsystem of the first server with the graphical model.

3. The system of claim 1, wherein the data includes one or more of an indication of location, an indication of volume changes, an indication of screen brightness changes, an indication of headphone connection, an indication of a network service status, and an indication of communications performed by the user device.

4. The system of claim 1, wherein the graphical model includes temporal data relating to the data, and wherein the intelligence report is generated by the personal cloud based on the temporal data.

5. The system of claim 1, wherein the graphical model is formatted using extensible markup language (XML).

6. The system of claim 1, wherein the at least one command comprises one or more of adjusting volume of the user device, adjusting screen brightness of the user device, executing an application stored within the user device, and transmitting a message from the user device.

7. The system of claim 1, wherein the personal cloud is operable to update the confidence level of the link between the first node and the second node responsive to receiving additional data relating to the first node and the second node from the user device.

8. The system of claim 1, wherein the personal cloud is operable to update the confidence level of the link between the first node and the second node responsive to receiving additional data relating to the first node and the second node from the graph engine.

9. The system of claim 1, wherein the personal cloud is operable to generate the at least one command based on the confidence level when the confidence level is above a threshold.

10. An apparatus, comprising:
a first server providing a personal cloud that is accessible to a user through a user device communicatively coupled to the first server via a network; and
a data storage system storing a personal cloud database that is maintained by the first server, the personal cloud database comprising a plurality of graphical models generated by the personal cloud based on data received from the user device, the plurality of graphical models including at least one graphical model comprising a first node, a second node, and a confidence level indicating a connection between the first node and the second node;
wherein the personal cloud is operable to transmit an abstracted form of the at least one graphical model to a second server providing a graph engine and communicatively coupled via the network to the first server;
wherein, upon receiving an indication from the second server of a loop between the first node, the second node, and a third node of a graphical model maintained by the graph engine, the personal cloud is operable to generate an intelligence report including at least one command based on the indication of the loop and the confidence level; and
wherein the personal cloud is further operable to transmit the intelligence report to the user device responsive to the confidence level above a threshold.

11. The apparatus of claim 10, wherein the personal cloud is operable to update the confidence level responsive to receiving additional data relating to the first node and the second node from the user device.

12. The apparatus of claim 10, wherein the data includes one or more of an indication of location, an indication of volume changes, an indication of screen brightness changes, an indication of headphone connection, an indication of a network service status, and an indication of communications performed by the user device.

13. The apparatus of claim 10, wherein the at least one command comprises one or more of adjusting volume of the user device, adjusting screen brightness of the user device, executing an application stored within the user device, and transmitting a message from the user device.

14. The apparatus of claim 10, wherein the personal cloud is operable to transmit the intelligence report to the user device responsive to a second confidence level above a threshold, the second confidence level indicating a connection between the first node and the third node.

15. A method, comprising:
providing, at a first server, a personal cloud that is accessible to a user through a user device communicatively coupled to the first server via a network;
maintaining, in a data storage system, a personal cloud database comprising a plurality of graphical models generated by the personal cloud based on data received from the user device, the plurality of graphical models including at least one graphical model comprising a first node, a second node, and a confidence level indicating a connection between the first node and the second node;
transmitting an abstracted form of the at least one graphical model to a second server providing a graph engine and communicatively coupled via the network to the first server;
receiving an indication from the second server of a loop between the first node, the second node, and a third node of a graphical model maintained by the graph engine;
generating an intelligence report including at least one command based on the indication of the loop and the confidence level; and
transmitting the intelligence report to the user device responsive to the confidence level above a threshold.

16. The method of claim 15, further comprising updating the confidence level stored in the personal cloud database responsive to receiving additional data relating to the first node and the second node from the user device.

17. The method of claim 15, further comprising updating the confidence level stored in the personal cloud database responsive to receiving additional data relating to the first node and the second node from the second server.

18. The method of claim 15, wherein the data received from the user device includes one or more of an indication of location, an indication of volume changes, an indication of screen brightness changes, an indication of headphone connection, an indication of a network service status, and an indication of communications performed by the user device.

19. The method of claim 15, wherein the at least one command comprises one or more of adjusting volume of the user device, adjusting screen brightness of the user device, executing an application stored within the user device, and transmitting a message from the user device.

20. The method of claim 15, wherein the at least one graphical model includes temporal data relating to the data, and wherein the intelligence report is generated based on the temporal data.
